(19) United States
(12) Patent Application Publication
(10) Pub. No.: US 2016/0371734 A1
(43) Pub. Date: Dec. 22, 2016

(54) MAXIMIZING RELEVANCE OF DELIVERED DATA USING A SINGLE COMMON IDENTIFIER

(71) Applicant: Yahoo! Inc., Sunnyvale, CA (US)

(72) Inventor: Tyler Anthony Ziemann, San Francisco, CA (US)

(21) Appl. No.: 15/187,250

(22) Filed: Jun. 20, 2016

Related U.S. Application Data
(63) Continuation of application No. 12/361,698, filed on Jan. 29, 2009, now abandoned.

(51) Int. Cl. G06Q 30/02; G06F 17/30

(52) U.S. Cl. CPC G06Q 30/0263; G06F 17/30598

(57) ABSTRACT

System and method for displaying a data object together with its affiliate's additional object in a web page is provided. For each of a plurality of data objects, assign a unique content identifier and associate a category identifier that indicates to which one of the plurality of categories the data object belongs. An affiliate may be associated with individual data objects or an entire category of data objects. The content identifier of the data object or the category identifier of the category is associated with the affiliate. Each time one of the plurality of data objects is included in a web page, if the data object is associated with an affiliate or if the category to which the data object belongs is associated with an affiliate, then the data object is positioned in the web page together with an additional object associated with the affiliate.

### PRIORITY CLAIM

This application claims the benefit of domestic priority under 35 U.S.C. §120 as a Continuation of U.S. patent application Ser. No. 12/361,698, filed Jan. 29, 2009, the entire contents of which are hereby incorporated by reference as if fully set forth herein. The applicant hereby rescinds any disclaimer of claim scope in the parent application or the prosecution history thereof, and advises the USPTO that the claims in this application may be broader than any claim in the parent applications.

### TECHNICAL FIELD

The present disclosure generally relates to Internet data selection and more specifically relates to matching data objects with affiliates so that additional objects associated with the affiliates are delivered together with the matching data objects.

### Suggested Group Art Unit: 2184; Suggested Classification: 710.

### BACKGROUND

A content piece such as a story may be a data object to be delivered within a requested web page. Likewise, a banner advertisement may be an additional object that is selected for inclusion within the web page because of its relevance to the content piece.

Advertising on the Internet has grown into a multi-billion-dollar business. In a common scenario, an advertising service provider provides the Internet advertising medium. The advertising medium may take various forms, such as web pages, live feeds, electronic messages, etc. An advertiser, also referred to as a sponsor, may purchase a certain amount of advertising space from the advertising service provider to place its advertisements in the advertising medium provided by the advertising service provider. For example, it is common to find sponsors' logos, ad banners, and/or other forms of advertisements, e.g., clickable images or texts, etc., included in web pages along with the primary content of the web pages.

FIGS. 1A and 1B together illustrates a sample web page 100. FIG. 1A includes the top portion of the web page 100, and FIG. 1B includes the bottom portion of the web page 100. The web page 100 is in fact the home page of the web site “www.yahoo.com,” which is provided and maintained by Yahoo!® Inc. The web page 100 is divided into multiple modules, e.g., the modules 110, 120, 130, 140, 150, 160, 170, 180, and 190. Within each module there is various information, which may be the actual content of the web page 100 or advertisements. For example, in the module 110, there are components, e.g., text field, button, etc., that enable users to conduct search operations. In the module 120, there are clickable categories. In the modules 130 and 150, there are clickable news articles. In the module 160, there is a clickable advertisement.

In this example, Yahoo!® Inc. is the advertising service provider, and the web page 100 is the advertising medium. An advertiser who wishes to place its advertisement in the web page 100 may purchase a portion of the web page 100, such as the module 160, for some period of time. During that period of time, the advertiser's advertisement appears in the space of the web page 100 that the advertiser has purchased.

Although in theory, there is no limit to the amount of space a web page may have and to the number of web pages on the Internet, in practice, there often is a limit to the amount of space that each web page has and to the number of web pages on the Internet due to computing resource, e.g., memory, processor, etc., limitations. Moreover, there is a limited amount of valuable space in each web page; that is, space that receives viewers' attention since a viewer often reads only a portion of a web page, perhaps due to lack of time or lack of patience. Often, within each web page, the available space is divided between the actual content of the web page and advertisements. Thus, the amount of space available for advertising is even more limited. In addition, to attract visitors and to make web pages more readable, it may not be desirable to place too much information within each web page. Instead, a streamlined and efficient web page design approach may achieve better results.

### SUMMARY

The present disclosure generally relates to Internet advertising and more specifically relates to matching content pieces with sponsor advertisers so that advertisements associated with the sponsor advertisers are displayed together with the matching content pieces.

According to various embodiments, content pieces are created and stored in one or more databases so that they may be displayed in selected web pages. There are a number of categories and optionally, within some of the categories, there are a number of sub-categories. Each category and sub-category has a unique category identifier (ID). Each content piece is assigned a category ID that indicates the category or sub-category to which the content piece belongs. In addition, each content piece is assigned a unique content identifier (ID).

An advertiser may purchase, i.e., sponsor, one or more categories, one or more sub-categories, or one or more specific content pieces for a period of time. Thereafter, during that period of time, the advertiser's advertisement is displayed together with the content pieces the advertiser has purchased.

More specifically, if the advertiser has purchased a category, then each time a content piece belonging to that category is displayed in a web page, the advertiser's advertisement is displayed with the content piece. If the advertiser has purchased a sub-category, then each time a content piece belonging to that sub-category is displayed in a web page, the advertiser's advertisement is displayed with the content piece. The category ID assigned to each content piece indicates to which category or sub-category the content piece belongs, which is used to match the content piece with the category or sub-category the advertiser has purchased.

Furthermore, if the advertiser has purchased individual content pieces, then each time one or those content pieces is displayed in a web page, the advertiser's advertisement is displayed with the content piece. The content ID indicates the individual content pieces that the advertiser has purchased.

According to various embodiments, with the purchase of one or more categories, one or more sub-categories, or one or more specific content pieces for a period of time, the advertiser is guaranteed a minimum number of impressions of its advertisement during that period of time. According to various embodiments, each time an advertisement is displayed in a web page is considered one impression.

According to various embodiments, the content pieces are displayed according to their respect levels of popularity. The relatively more popular a content piece, the relatively more often and/or in relatively more prominent position in a web page the content piece is displayed. The levels of popularity for the content pieces may be determined based on user feedbacks.

These and other features, aspects, and advantages of the disclosure are described in more detail below in the detailed description and in conjunction with the following figures.

### BRIEF DESCRIPTION OF THE DRAWINGS

The present disclosure is illustrated by way of example, and not by way of limitation, in the figures of the accompanying drawings and in which like reference numerals refer to similar elements and in which:

FIGS. 1A and 1B together illustrates a sample web page.

FIG. 2 illustrates a system for associating advertisements with content pieces sponsored by advertisers associated with the advertisements according to one embodiment of the present disclosure.

FIG. 3 illustrates a method of managing content pieces according to one embodiment of the present disclosure.

FIG. 4 illustrates a method of obtaining sponsors for content pieces according to one embodiment of the present disclosure.

FIG. 5 illustrates a method of displaying content pieces with advertisements associated with the sponsors of the content pieces according to one embodiment of the present disclosure.

FIGS. 6A and 6B illustrate two versions of a sample web page constructed using the system illustrated in FIG. 2.

FIG. 7 illustrates a general computer system suitable for implementing embodiments of the present disclosure.

### DETAILED DESCRIPTION

The present disclosure is now described in detail with reference to a few preferred embodiments thereof as illustrated in the accompanying drawings. In the following description, numerous specific details are set forth in order to provide a thorough understanding of the present disclosure. It is apparent, however, to one skilled in the art, that the present disclosure may be practiced without some or all of these specific details. In other instances, well known process steps and/or structures have not been described in detail in order to not unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

According to various embodiments of the present disclosure, content pieces are created and stored in one or more databases so that they may be displayed in selected web pages. Each content piece is assigned a category identifier (ID) and a unique content identifier (ID). The category ID indicates the category or sub-category to which the content piece belongs.

Advertisers may choose to sponsor one or more categories, one or more sub-categories, or one or more content pieces for a period of time. Thereafter, during that period of time, each time a content piece is displayed in a web page, an advertisement associated with the sponsor of the content piece is displayed together with the content pieces. A content piece and its sponsor is matched using the content piece's category ID or content ID.

According to various embodiments, when an advertiser sponsors a particular category, sub-category, or content piece, the advertiser is guaranteed that its advertisement is displayed a minimum number of times in web pages along with one or more content pieces during the period of time that the advertiser has purchased. In other words, the advertiser is guaranteed a minimum number of impressions of its advertisement during the period of time that the advertiser has purchased.

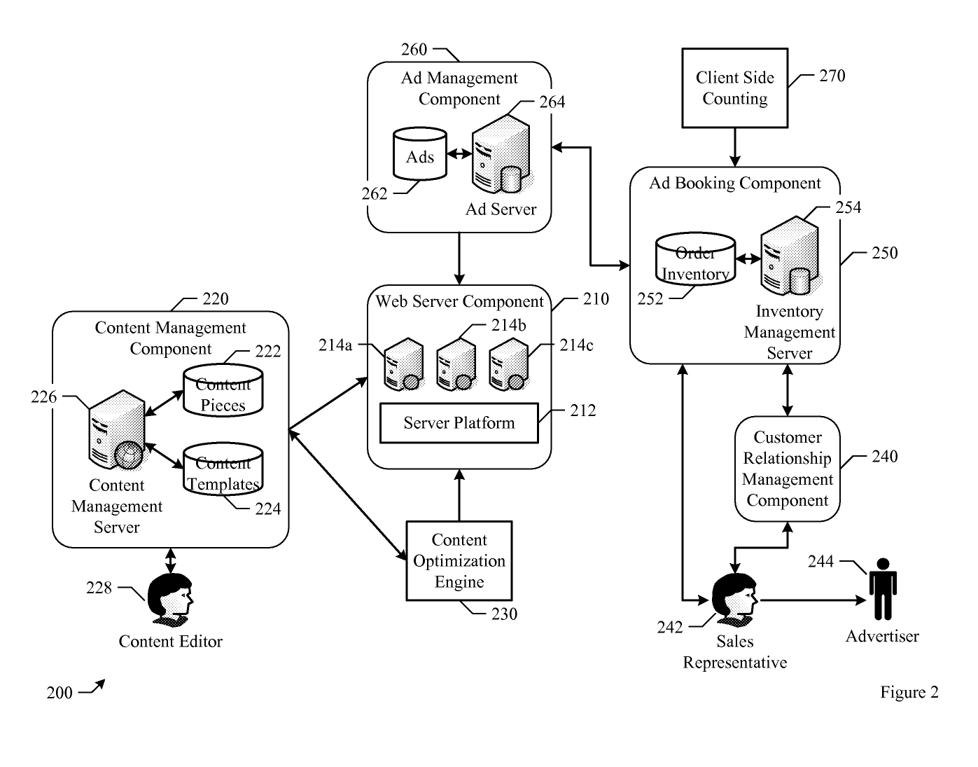

FIG. 2 illustrates a system 200 for associating advertisements with content pieces sponsored by advertisers associated with the advertisements according to one embodiment of the present disclosure. The system 200 contains several components.

The web server component 210 is responsible for displaying content pieces and their associated advertisements in the web pages. According to one embodiment, the web server component 210 includes a server platform 212 and one or more application servers, such as the servers 214a, 214b, and 214c. When the web server component 210 receives a client request for a web page, one of the application servers, the server 214a, 214b, or 214c, generates the requested web page by selecting and placing the appropriate content pieces in the web page and placing advertisements associated with some of the content pieces in the appropriate positions in the web page, e.g., next to their associated content pieces, and sends the web page to the client that has requested the web page. The server platform 212 may obtain the necessary content pieces from the content management component 220 and advertisements from the ad management component 260 for the servers 214a, 214b, and 214c.

The content management component 220 is responsible for creating and managing the content pieces that are to be displayed in the web pages. According to one embodiment, the content management component 220 includes a database 222 for storing the content pieces that are ready to be displayed in the web pages, a database 224 for storing the templates for the content pieces that may be used to create new content pieces, and a content management server 226 that manages the content pieces stored in the database 222 and the content templates stored in the database 224. Any person, such as a content editor 228, may create new content pieces, modify existing content pieces stored in the database 222, and/or delete content pieces from the database 222 via the content management server 226.

The content optimization engine 230 may optionally optimizes the content pieces stored in the database 222. According to one embodiment, the content pieces stored in the database 222 are ranked based on their relative levels of popularity among the viewers of the web pages. The relative level of popularity of a content piece may be determined, in part, based on viewer feedbacks, which may be represented using statistical data such as click-through-rate. The relatively more popular a content pieces, the relatively more often that content piece is displayed or in relatively more prominent position that content pieces is displayed in the web pages.

The customer relationship management component 240 is responsible for estimating the number of impressions available for a web site on a given day. An impression count indicates the number of times an advertisement is delivered to potential customers, consumers, or other members of the advertising audience during a specific period of time. According to one embodiment, each time an advertisement is displayed in a web page, it is considered one impression. Other delivery methods may also contribute to the total number of impressions that an advertisement is delivered to the advertising audience. For example, each time an advertisement is emailed to a person or sent to a person's mobile device may be considered one impression. The customer relationship management component 240 estimates the total number of impressions a web site, which may include multiple web pages, may deliver advertisements to its viewers. This information may help the advertising service providers to sell advertising spaces in it web pages.

An employee of the advertising service provider, e.g., a sales representative 242, may sell advertising space in the web pages provided by the advertising service provider to the advertisers, e.g., the advertiser 244, and guarantees to the advertiser 244 a minimum of impressions for the advertiser's 244 advertisements during a specific period of time. In other words, the advertiser's 244 advertisement is guaranteed to be displayed a minimum number of times in the web pages provided by the advertising service provider.

The ad booking component 250 is responsible for booking and managing advertising orders. According to one embodiment, the ad book component 250 includes a database 252 for storing the advertising orders and an inventory management server 254 that manages the advertising orders stored in the database 252. The sales representative 242 may store new advertising orders in the database 252 via the inventory management server 254.

The ad management system 260 is responsible for selecting advertisements to be displayed in the web pages based on the advertising orders stored in the database 252. According to one embodiment, the includes a database 262 for storing all the advertisements associated with the advertisers who have purchased advertising spaces in the web pages provided by the advertising service provider and a ad server 264 that manages the advertisements stored in the database 262. When the web server component 210 generates a web page in response to a client request, the ad server 264 may select the appropriate advertisements from the database 262 and forward the advertisements to the web server component 210 to be displayed in the web page.

The client side counting component 270 is responsible for monitoring, counting, and validating the number of impressions each advertisement has been delivered, i.e., the number of times each advertisement has been displayed in the web pages. The information may be used to determine whether the advertising service provider has met its obligation in terms of the minimum number of impressions the advertising service provider guarantees the advertiser 244 of the advertiser's 244 advertisement.

Some of the components illustrated in the system 200 are described in more detail below.

### The Content Management Component

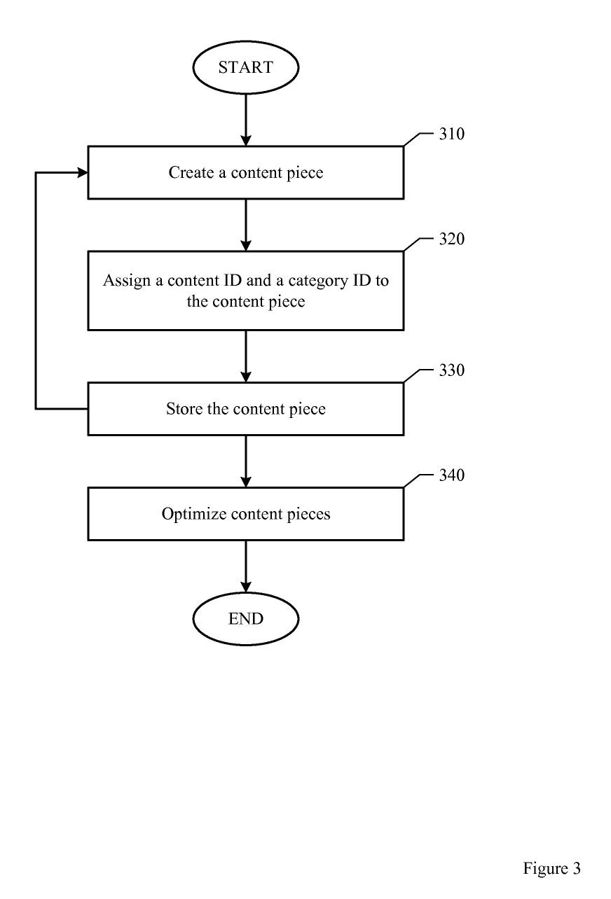

The content management component 220 may be responsible for creating and editing content pieces that are to be displayed in the web pages. According to one embodiment, any person may create new content pieces and store these content pieces in one or more databases, such as the database 222, via the content management server 226. FIG. 3 illustrates a method of creating content pieces according to one embodiment of the present disclosure.

A person, e.g., the content editor 228, may create a new content piece via the content management server 226 (step 310). Optionally, the content editor 228 may choose one of the many content templates stored in the database 224 as a starting point. The content templates may be designed based on popular styles for web page modules. For example, the content templates may include poll template, slideshow template, list template, “top 10” template, etc. Alternatively, the content editor 228 may create a new content piece from scratch, i.e., without using any template.

The content piece is assigned a unique content identifier (ID) and a category ID (step 320). The content ID is unique among all the existing content pieces and may be used to distinguish one content piece from other content pieces.

The content piece is categorized to one of several predefined categories based on the actual content of the piece. For example, content categories may include finance, entertainment, news, sports, automobiles, etc. Some of the categories may be further divided into sub-categories. For example, under the sports category there may be sub-categories such as football, basketball, ski, running, etc., and under the entertainment category there may be sub-categories such as movies, music, games, etc. A video about a recent basketball game may be appropriately assigned to the “basketball” sub-category, and an article analyzing the recent trend of the stock market may be appropriately assigned to the “finance” category. Each category or sub-category has a unique category ID. The content piece is associated with the category ID of the category or sub-category to which the content piece belongs. Thereafter, the content piece's category ID indicates to which category or sub-category the content piece belongs.

Once the content piece is finalized, the content piece is stored in the database 222 so that it may be displayed in the web pages thereafter (step 330). Steps 310, 320, and 330 may be repeated multiple times to create multiple new content pieces.

In addition, the content pieces stored in the database 222 may be optimized by the content optimization engine 230 (step 340). According to one embodiment, as content pieces are displayed in the web pages, viewer interactions with these content pieces are monitored and statistic information regarding such interactions is collected. Some of the viewer interactions include viewer clicking on the content pieces, viewer reading or watching the content pieces, viewer clicking on links provided in the content pieces, viewer sending the content pieces to other viewers, viewer book-marking the content pieces, viewer rating or commenting on the content pieces, etc. Such information may be used to determine relative levels of popularity of the content pieces among the viewers. According to one embodiment, within each category or sub-category, the content pieces are ranked based on their relative levels of popularity. Such ranking may be used to determine how content pieces are to be displayed in the web pages. For example, more popular content pieces may be displayed more often or in more prominent positions in the web pages. Web pages that include the more popular content pieces may be better received among the viewers, and consequently, such web pages may provide more enjoyable experiences or more useful information to the viewers.

According to one embodiment, the content optimization engine 230 or the content management system 220 provides feedback information to the content editor 228 to help the content editor 228 improve the quality of the content pieces as well as the website where the content pieces are displayed. The feedback information includes past performance data collected on the individual content pieces. According to one embodiment, the performance data is displayed to the content editor 228 at the hour granularity—that is, the data is updated every hour. The data may be displayed on different levels. At a higher level, the performance data may indicate the period of time a content piece is displayed, when the content piece performance above or below average, etc. At a lower level, the performance data may indicate each individual link within a content piece and its performance. According to one embodiment, a heat-map may be used to show the performance of the web pages and of the modules or links within the web pages.

### The Ad Booking Component

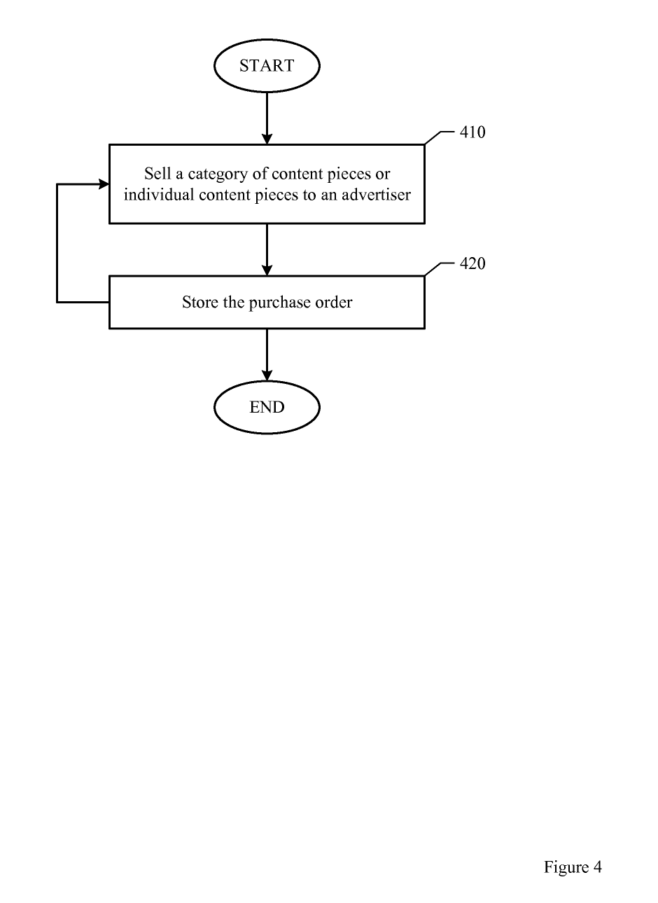

The ad booking component 250 may be responsible for booking advertising orders. According to one embodiment, an employee of the advertising service provider, e.g., the sales representative 242, may sell sponsorship of the content pieces to be displayed in the web pages provided by the advertising service provider to advertisers, e.g., the advertiser 244. FIG. 4 illustrates a method of obtaining sponsors for content pieces according to one embodiment of the present disclosure.

The advertiser 244 has the choice of sponsoring an entire category, an entire sub-category, or individual content pieces (step 410). The price of sponsorship may vary. Generally, the more content pieces the advertiser 244 sponsors and/or the longer time of sponsorship, the higher the price. If the advertiser 244 chooses to sponsor an entire category, then the advertiser 244 sponsors all the content pieces belonging to that category. Similarly, if the advertiser 244 chooses to sponsor an entire sub-category, then the advertiser 244 sponsors all the content pieces belonging to that sub-category. The category or sub-category that the advertiser 244 chooses to sponsor is indicated by the corresponding category ID assigned to the category or sub-category.

Alternatively, the advertiser 244 may choose to sponsor individual content pieces. For example, certain content pieces may be especially relevant to a particular advertiser. In this case, the advertiser may not need to pay the higher price in order to sponsor an entire category. Instead, the advertiser may choose to only sponsor those specific content pieces. Furthermore, the advertiser may choose to sponsor individual content pieces from different categories or sub-categories if so desires. The individual content pieces that the advertiser 244 chooses to sponsor are indicated by the corresponding unique content IDs assigned to the content pieces.

Once the advertiser 244 has chosen to sponsor a category, a sub-category, or one or more content pieces, the purchase order is stored in the database 252 (step 420).

According to one embodiment, by sponsoring a category, a sub-category, or one or more content pieces, the advertiser 244 is guaranteed a minimum number of impressions of its advertisement during a specific period of time. The actual number of impressions of advertisement guaranteed may depend on the category, sub-category, or content pieces the advertiser 244 has chosen to sponsor, as well as the length of sponsorship. In general, the more content pieces the advertiser 244 has chosen to sponsor and/or the longer time of sponsorship, the higher minimum number of impressions is guaranteed.

### The Web Server Component

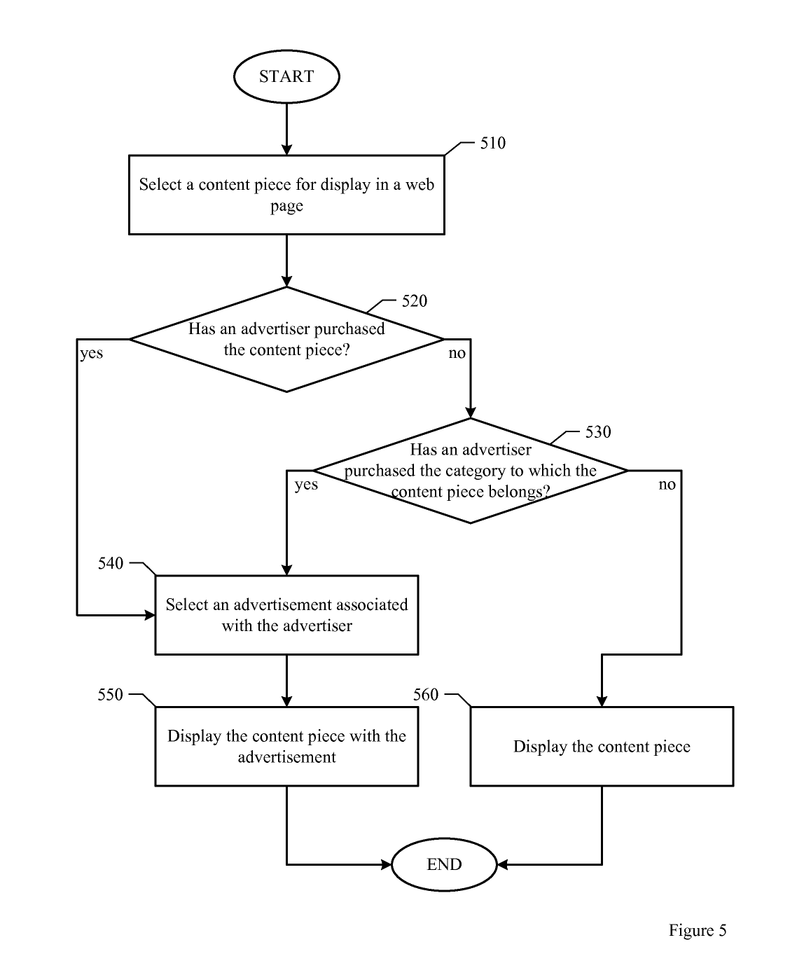

The web server component 210 is responsible for generating web pages that include both content pieces and advertisements in response to client requests. FIG. 5 illustrates a method of displaying content pieces with advertisements associated with the sponsors of the content pieces according to one embodiment of the present disclosure. The content pieces are stored in the database 222. The advertisements associated with the advertisers who have paid to sponsor various content pieces are stored in the database 262.

When the web server component 210 receives a client request for a web page, it selects an appropriate content piece to be included in the web page (step 510). Often, a web page may include multiple content pieces, and some content pieces may have sponsors while other content pieces may not have any sponsor. According to one embodiment, the content management component 220 may help determine which content pieces are suitable to be included in the web page.

According to one embodiment, the content pieces selected for the web page may be personalized for individual users—that is, different content pieces are selected for different users who have initiated the client requests based on user preferences. According to one embodiment, the personalization may be based on past user behavior. User actions across multiple sections of a web portal are tracked and data relating to these actions is collected. The user behavior data may be used to determine the type of content pieces a user may enjoy. When a user initiates a request for more content pieces, those content pieces that are similar to the type of content pieces that the user has enjoyed in the past may be selected first, since it is more likely that the user will enjoy these content pieces as well.

A determination is made as to whether an advertiser has purchased, i.e., sponsored, the selected content piece (step 520). According to one embodiment, the determination is made based on the purchase orders stored in the database 252. If an advertiser has sponsored a particular content piece, the unique content ID associated with the content piece is indicated in the purchase order from the advertiser. In this case, an advertisement associated with the sponsor advertiser is selected (step 540). On the other hand, if no advertiser has sponsored the selected content piece, then a determination is made as to whether an advertiser has sponsored the category or sub-category to which the content piece belongs (step 530).

According to one embodiment, again, the determination is made based on the purchase orders stored in the database 252. If an advertiser has sponsored a particular category or sub-category, the category ID associated with the category or sub-category is indicated in the purchase order from the advertiser. The category ID associated with the content piece may be compared against each of the category IDs indicated in the purchase orders from all the advertisers to determine whether a particular advertiser has sponsored the category or sub-category to which the content piece belongs.

If an advertiser has sponsored the category or sub-category to which the content piece belongs, then an advertisement associated with the advertiser is selected (step 540). According to one embodiment, the ad management component 260 may help determine which advertisement associated with the sponsor advertiser is suitable for the particular content piece selected for the web page. Sometimes, an advertiser may have several advertisements, and these advertisements are stored in the database 262 along with advertisements associated with other advertisers. An advertisement may take various forms, such as a logo, a slogan, an image, a video clip, a few lines of text, a banner, etc. The ad server 264 may select one of several available advertisements associated with the sponsor advertiser stored in the database 262 for the particular content piece based on the actual content, format, and/or style of the content piece itself or of the web page on which the content piece is displayed. The particular content piece and the advertisement associated with the sponsor advertiser are then displayed together on the web page (step 550).

On the other hand, if no advertiser has sponsored the content piece or the category or sub-category to which the content piece belongs, then the content piece is displayed by itself without any advertisement on the web page (step 560).

According to one embodiment, if one advertiser has sponsored a particular content piece as an individual content piece and another advertiser has sponsored the category to which the particular content piece belongs at the same time, then when the content piece is included in a web page, the advertisement associated with the first advertiser, i.e., the advertiser who has sponsored the content piece as an individual content piece, is displayed with the content piece.

The steps illustrated in FIG. 5 may be repeated for each of the content pieces included in the web page. Consequently, those content pieces include in the web page that do not have any sponsor are displayed by themselves, while those content pieces include in the web page that have sponsors are displayed together with the advertisements associated with their respective sponsors. The content pieces are matched with their sponsors using their content IDs or category IDs.

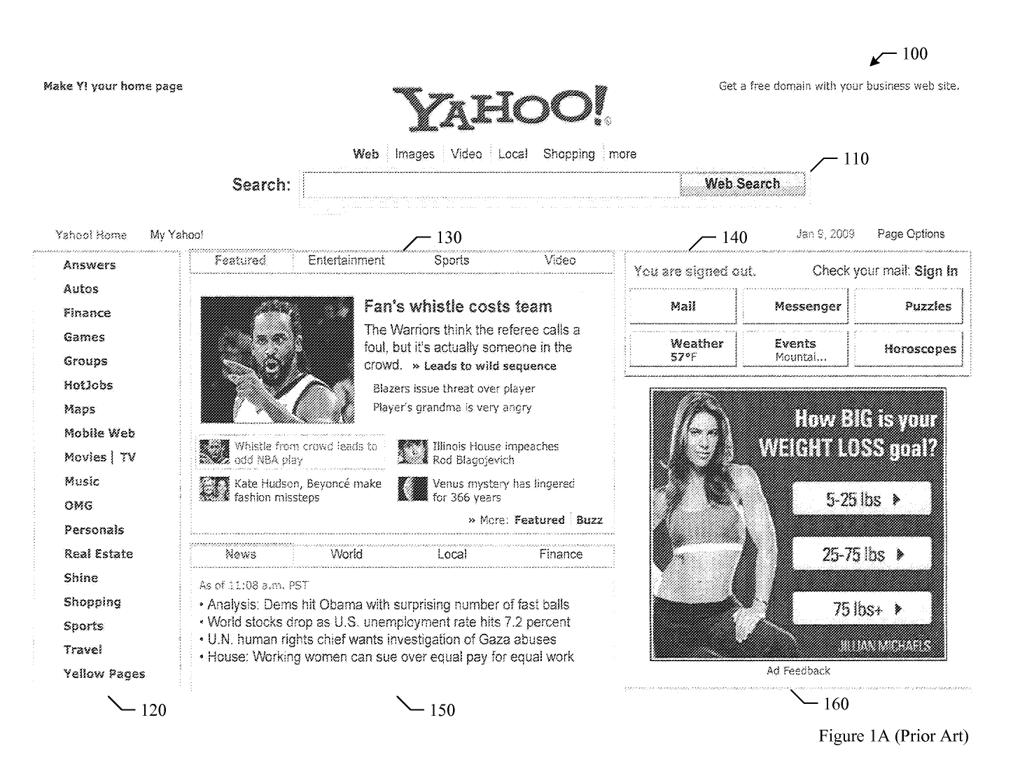

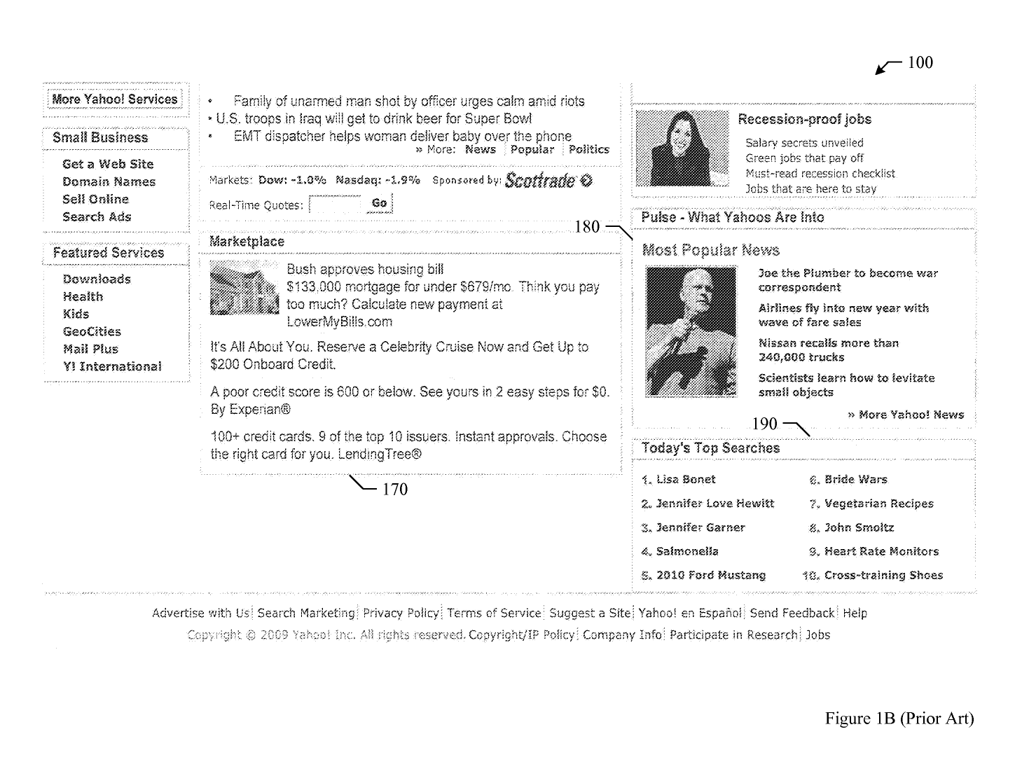

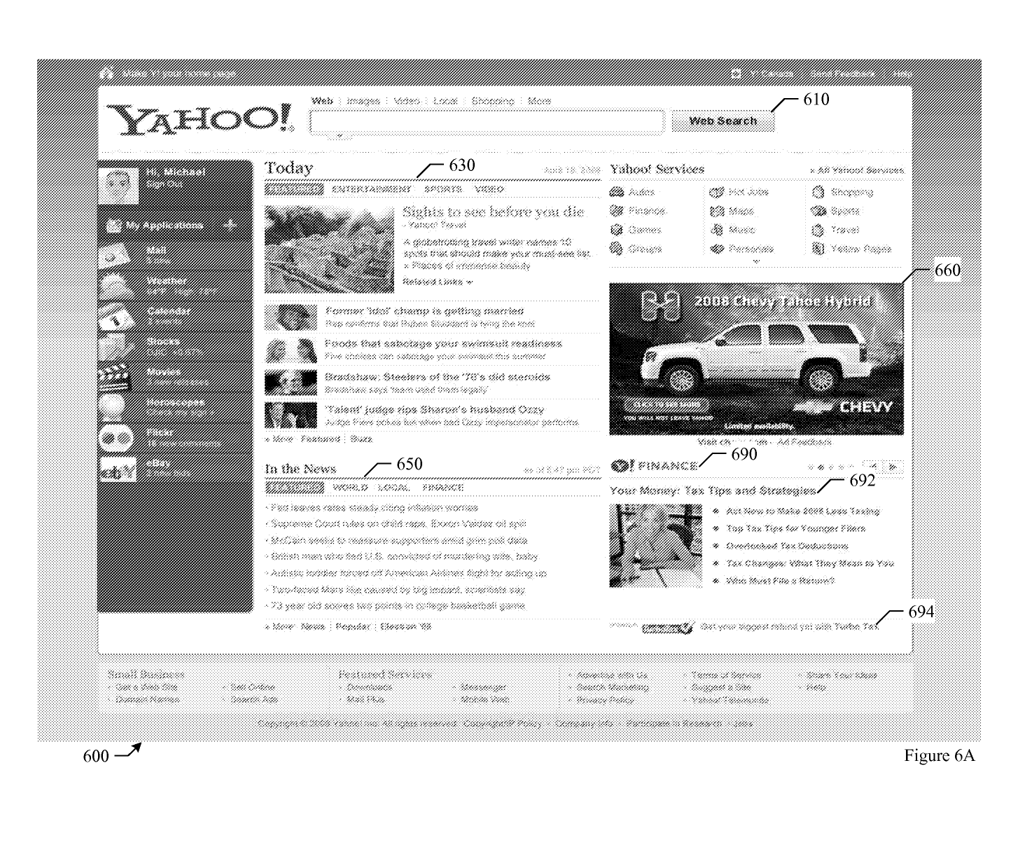

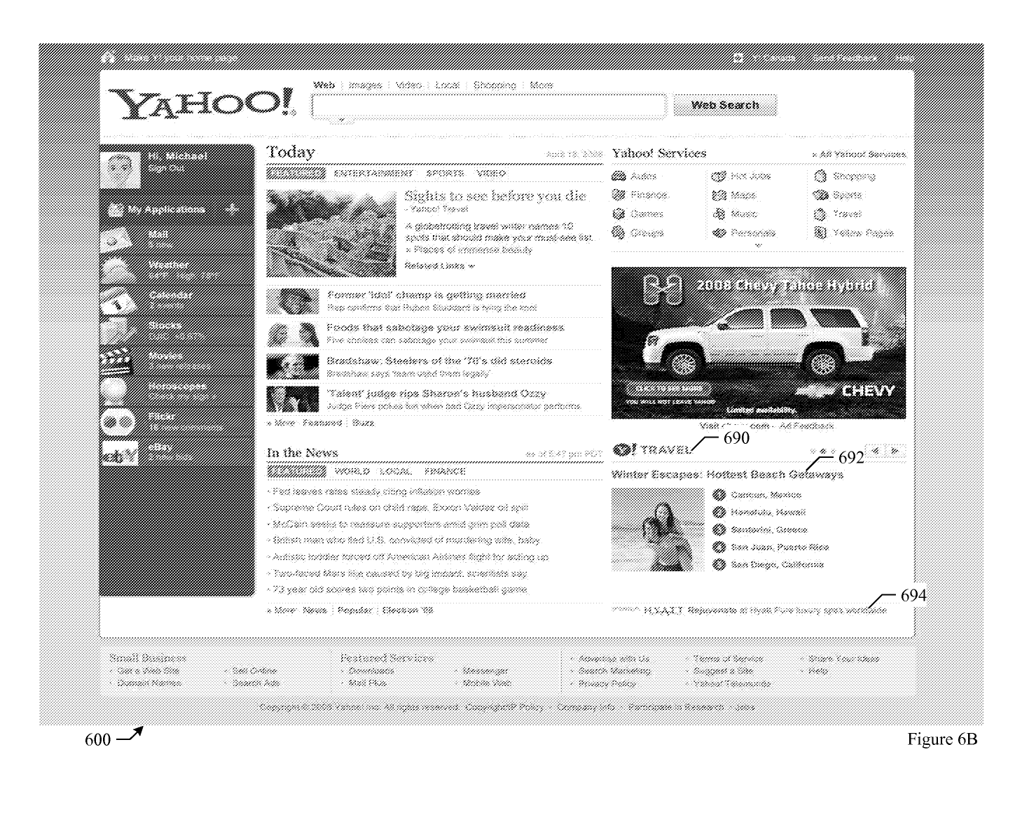

FIG. 6A illustrates one version of a sample web page 600 constructed using the system illustrated in FIG. 2 and the methods illustrated in FIGS. 3-5. Similar to the web page 100 as illustrated in FIGS. 1A and 1B, the web page 600 are divided into several modules, such as the modules 610, 630, 650, 660, and 690. Within each module are various pieces of content, i.e., actual content of the web page 600. For example, the module 630 includes content pieces relating to today's featured stories and the module 650 includes content pieces relating to current local and world news. Some modules are reserved for advertisements. For example, the module 660 includes an automobile advertisement but does not include any content pieces.

The module 690 is used to display content pieces from the “finance” category. The content piece 692 displayed in the module 690 is about tax tips and strategies, and is appropriately categorized as belonging to the “finance” category. The content piece 692 is thus associated with the category ID for the “finance” category. In this example, an advertiser, Intuit, has sponsored the “finance” category. Since the content piece 692 belongs to the “finance” category, Intuit's advertisement 694 is displayed with the content piece 692, i.e., immediately below the content pieces 692. The advertisement 694 relates to Intuit's tax product, TurboTax, which is closely related to the actual content of the content piece 692.

Note that not all content pieces displayed in the web page 600 have corresponding advertisements. For example, the content pieces displayed in the modules 630 and 650 are not displayed with any advertisement. The advertising service provider may design its web pages in any format it desires. It may determine which content pieces are to be displayed with sponsors' advertisements and which content pieces are to be displayed alone. The advertising service provider may sell sponsorship to selected content pieces only.

The “finance” category may have many content pieces, and different content pieces may be displayed in the module 690 at different times. For example, the web page 600 may be dynamically constructed, and each time the web page 600 needs to be constructed in response to a client request, a different content piece may be displayed in the module 690. Since Intuit has sponsored the “finance” category, every time a content piece from the “finance” category is displayed in the module 690, an advertisement associated with Intuit is displayed below the content piece. However, the advertisement may also vary if Intuit has multiple advertisements.

Furthermore, the module 690 may be used to display content pieces from different categories at different times. For example, the next time the web page 600 is constructed in response to a different client request, the module 690 may be used to display a content piece from the “travel” category. If another advertiser has sponsored the “travel” category or that specific content piece, then an advertisement associated with that advertiser is displayed with the content piece instead. FIG. 6B illustrates a different version of the sample web page 100. This version is very similar to the version illustrated in FIG. 6A, except that a content piece 692 belonging to the “travel” category is displayed in the module 690. A different advertiser, Hyatt, has sponsored the “travel” category, and thus, an advertisement 694 associated with Hyatt is displayed in the module 690 with the content piece 692 belonging to the “travel” category.

### Computer System

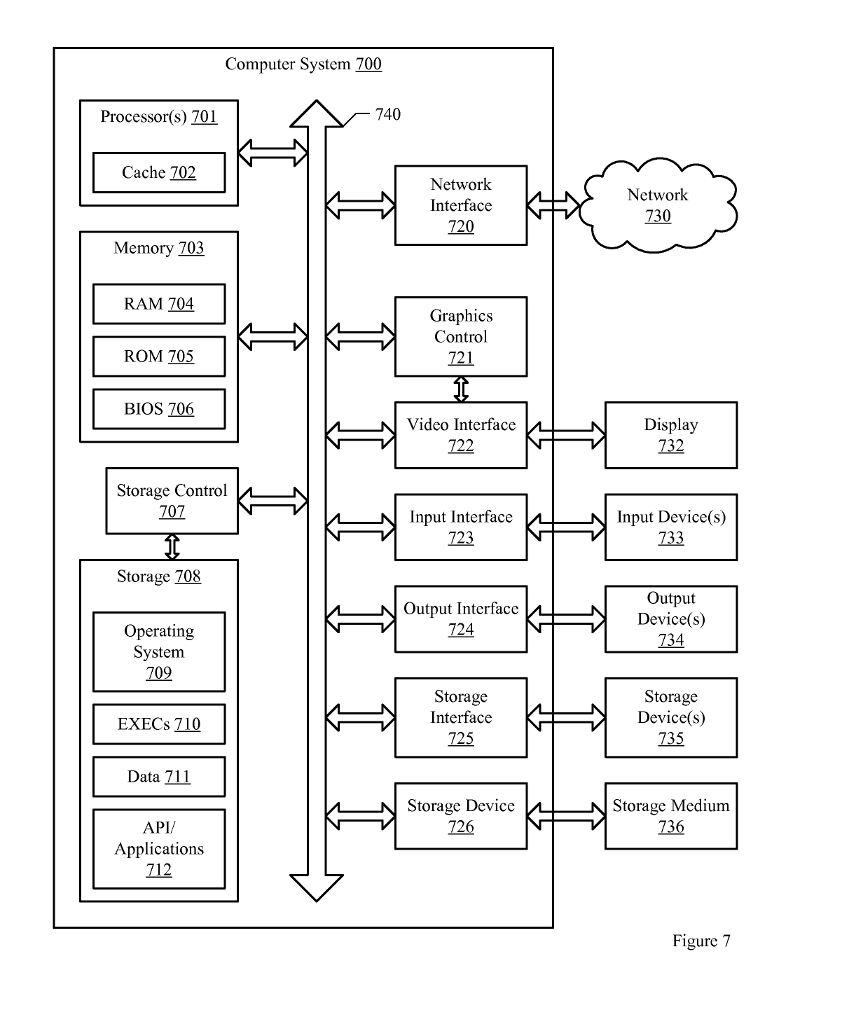

The advertising methods described above may be implemented as computer software using computer-readable instructions and physically stored in computer-readable medium. The computer software may be encoded using any suitable computer languages. The software instructions may be executed on various types of computers. For example, FIG. 7 illustrates a computer system 700 suitable for implementing embodiments of the present disclosure.

The components shown in FIG. 7 for computer system 700 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system. Computer system 700 may have many physical forms including an integrated circuit, a printed circuit board, a small handheld device (such as a mobile telephone or PDA), a personal computer or a super computer.

Computer system 700 includes a display 732, one or more input devices 733 (e.g., keypad, keyboard, mouse, stylus, etc.), one or more output devices 734 (e.g., speaker), one or more storage devices 735, various types of storage medium 736.

The system bus 740 link a wide variety of subsystems. As understood by those skilled in the art, a “bus” refers to a plurality of digital signal lines serving a common function. The system bus 740 may be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 701 (also referred to as central processing units, or CPUs) optionally contain a cache memory unit 702 for temporary local storage of instructions, data, or computer addresses. Processor(s) 701 are coupled to storage devices including memory 703. Memory 703 includes random access memory (RAM) 704 and read-only memory (ROM) 705. As is well known in the art, ROM 705 acts to transfer data and instructions uni-directionally to the processor(s) 701, and RAM 704 is used typically to transfer data and instructions in a bi-directional manner. Both of these types of memories may include any suitable of the computer-readable media described below.

A fixed storage 708 is also coupled bi-directionally to the processor(s) 701, optionally via a storage control unit 707. It provides additional data storage capacity and may also include any of the computer-readable media described below. Storage 708 may be used to store operating system 709, EXECs 710, application programs 712, data 711 and the like and is typically a secondary storage medium (such as a hard disk) that is slower than primary storage. It should be appreciated that the information retained within storage 708, may, in appropriate cases, be incorporated in standard fashion as virtual memory in memory 703.

Processor(s) 701 is also coupled to a variety of interfaces such as graphics control 721, video interface 722, input interface 723, output interface, storage interface, and these interfaces in tum are coupled to the appropriate devices. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 701 may be coupled to another computer or telecommunications network 730 using network interface 720. With such a network interface 720, it is contemplated that the CPU 701 might receive information from the network 730, or might output information to the network in the course of performing the above-described method steps. Furthermore, method embodiments of the present disclosure may execute solely upon CPU 701 or may execute over a network 730 such as the Internet in conjunction with a remote CPU 701 that shares a portion of the processing.

According to various embodiments, when in a network environment, i.e., when computer system 700 is connected to network 730, computer system 700 may communicate with other devices that are also connected to network 730. Communications may be sent to and from computer system 700 via network interface 720. For example, incoming communications, such as a request or a response from another device, in the form of one or more packets, may be received from network 730 at network interface 720 and stored in selected sections in memory 703 for processing. Outgoing communications, such as a request or a response to another device, again in the form of one or more packets, may also be stored in selected sections in memory 703 and sent out to network 730 at network interface 720. Processor(s) 701 may access these communication packets stored in memory 703 for processing.

In addition, embodiments of the present disclosure further relate to computer storage products with a computer-readable medium that have computer code thereon for performing various computer-implemented operations. The media and computer code may be those specially designed and constructed for the purposes of the present disclosure, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

As an example and not by way of limitation, the computer system having architecture 700 may provide functionality as a result of processor(s) 701 executing software embodied in one or more tangible, computer-readable media, such as memory 703. The software implementing various embodiments of the present disclosure may be stored in memory 703 and executed by processor(s) 701. A computer-readable medium may include one or more memory devices, according to particular needs. Memory 703 may read the software from one or more other computer-readable media, such as mass storage device(s) 735 or from one or more other sources via communication interface. The software may cause processor(s) 701 to execute particular processes or particular steps of particular processes described herein, including defining data structures stored in memory 703 and modifying such data structures according to the processes defined by the software. In addition or as an alternative, the computer system may provide functionality as a result of logic hardwired or otherwise embodied in a circuit, which may operate in place of or together with software to execute particular processes or particular steps of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

While this disclosure has described several preferred embodiments, there are alterations, permutations, and various substitute equivalents, which fall within the scope of this disclosure. It should also be noted that there are many alternative ways of implementing the methods and apparatuses of the present disclosure. It is therefore intended that the following appended claims be interpreted as including all such alterations, permutations, and various substitute equivalents as fall within the true spirit and scope of the present disclosure.

What is claimed is:

1. A system, comprising:
a first manager configured to manage a plurality of data objects, wherein each one of the plurality of data objects is assigned a unique content identifier, wherein each one of the plurality of data objects is associated with a category identifier that indicates to which one of a plurality of categories the data object belongs, and wherein each one of the plurality of categories is assigned a unique category identifier;
a second manager configured to manage a plurality of additional objects, wherein selected ones of the plurality of additional objects are associated with selected ones of a plurality of affiliates; and
a web application component configured to construct web pages in response to client requests, wherein each web page comprises at least one data object selected from the plurality of data objects, such that
if a data object is associated with an affiliate according to the content identifier assigned to the data object, then the data object is positioned in the web page together with an additional object associated with the affiliate;
if a data object is not associated with any affiliate, then
if the category to which the data object belongs is associated with an affiliate according to the category identifier associated with the data object, then the data object is positioned in the web page together with an additional object associated with the affiliate; and
if the category to which the data object belongs is not associated with any affiliate, then the data object is positioned in the web page by itself.
